(19) United States
(12) Patent Application Publication
(10) Pub. No.: US 2026/0186760 A1
(43) Pub. Date: Jul. 2, 2026

(54) RELAY DEVICE, PROGRAM, AND METHOD FOR UPDATING PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Takuya KOBAYASHI, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/727,983

(22) PCT Filed: Dec. 27, 2022
(86) PCT No.: PCT/JP2022/048077

§ 371 Date: Jul. 10, 2024

(30) Foreign Application Priority Data
Jan. 12, 2022 (JP) 2022-003273

(51) Int. Cl. G06F 8/65; B60R 16/023

(52) U.S. Cl. CPC G06F 8/65; B60R 16/023

(57) ABSTRACT

A relay device for obtaining an update program transmitted from a vehicle-outside device and performing processing for updating a program of an in-vehicle ECU mounted in a vehicle, the relay device including: a control unit for performing relay processing with the in-vehicle ECU; and a storage unit having stored thereon a relay processing program used for relay processing and a switch program for switching between relay processing and update processing; in which the control unit: obtains an update processing program for performing update processing from the vehicle-outside device; stores the obtained update processing program in the storage unit by using a storage area where the relay processing program is stored; and executes the update processing program stored in the storage unit; and while executing the update processing program, the control unit outputs the update program obtained from the vehicle-outside device to the in-vehicle ECU to be updated.

### CROSS-REFERENCE TO RELATED APPLICATIONS

This application is the U.S. national stage of PCT/JP2022/048077 filed on Dec. 27, 2022, which claims priority of Japanese Patent Application No. JP 2022-003273 filed on Jan. 12, 2022, the contents of which are incorporated herein.

### TECHNICAL FIELD

The present disclosure relates to a relay device, a program, and a method for updating a program.

### BACKGROUND

A vehicle is equipped with ECUs (Electronic Control Units) for controlling in-vehicle devices such as devices of a drive control system for controlling an engine and the like, and a body system for controlling an air conditioner and the like. The ECUs each include a computational processing unit such as an MPU, a rewritable nonvolatile storage unit such as a RAM, and a communication unit for communicating with other ECUs, and controls the in-vehicle devices by loading and executing a control program stored in a storage unit. Furthermore, a communication device having a wireless communication function is mounted in the vehicle, and the vehicle can communicate with a program providing device connected to a network outside the vehicle via the communication device, download (receive) a control program for an ECU from the program providing device, and update the control program of the ECU (for example, see JP 2017-97851A).

The communication device (relay device) of JP 2017-97851A has problems, such as, when the volume of a control program to be downloaded has increased, the storage volume of the storage unit increases, or when downloading the required control program, the control program is downloaded and updated in multiple sessions, which increases the time required for the entire update process.

An object of the present disclosure is to provide a relay device or the like capable of efficiently updating a program of an in-vehicle ECU when updating the program.

### SUMMARY

A relay device according to one aspect of the present disclosure is a relay device for obtaining an update program transmitted from a vehicle-outside device and performing processing for updating a program of an in-vehicle ECU mounted in a vehicle, the relay device including: a control unit for performing relay processing with the in-vehicle ECU; and a storage unit having stored thereon a relay processing program used during relay processing and a switch program for switching between relay processing and update processing; wherein while executing the switch program, the control unit: obtains an update processing program for performing update processing from the vehicle-outside device; stores the obtained update processing program in the storage unit by using a storage area where the relay processing program is stored; and executes the update processing program stored in the storage unit; and wherein while executing the update processing program, the control unit outputs the update program obtained from the vehicle-outside device to the in-vehicle ECU to be updated.

### Advantageous Effects

According to one embodiment of the present disclosure, it is possible to provide a relay device or the like capable of efficiently updating a program for an in-vehicle ECU when updating the program.

### BRIEF DESCRIPTION OF DRAWINGS

FIG. 1 is a schematic view illustrating the configuration of an in-vehicle update system including a relay device according to a first embodiment.

FIG. 2 is a block diagram illustrating a physical configuration of the relay device.

FIG. 3 is an explanatory view illustrating a state of a storage unit of the relay device.

FIG. 4 is a flowchart illustrating processing performed by a control unit of the relay device.

FIG. 5 is a flowchart about a second embodiment (compressing a non-generic program portion).

FIG. 6 is a block diagram illustrating a physical configuration of a relay device related to a third embodiment (a dual bank).

FIG. 7 is an explanatory view illustrating a state of a storage unit of the relay device.

FIG. 8 is a flowchart illustrating processing performed by a control unit of the relay device.

### DETAILED DESCRIPTION OF PREFERRED EMBODIMENTS

First, embodiments of the present disclosure will be listed and described. Note that at least some of the embodiments described below may be combined with each other as appropriate.

A relay device according to one aspect of the present disclosure is a relay device for obtaining an update program transmitted from a vehicle-outside device and performing processing for updating a program of an in-vehicle ECU mounted in a vehicle, the relay device including: a control unit for performing relay processing with the in-vehicle ECU; and a storage unit having stored thereon a relay processing program used during relay processing and a switch program for switching between relay processing and update processing; wherein while executing the switch program, the control unit: obtains an update processing program for performing update processing from the vehicle-outside device; stores the obtained update processing program in the storage unit by using a storage area where the relay processing program is stored; and executes the update processing program stored in the storage unit; and while executing the update processing program, the control unit outputs the update program obtained from the vehicle-outside device to the in-vehicle ECU to be updated.

In such an aspect, a control program executed by the control unit is stored in a storage unit of the vehicle-outside device, and the control program includes a switch program (self-reprogram program) and a relay program. The relay processing program corresponds to a program for normal control of the vehicle to perform functions during normal control such as when the vehicle is traveling. By executing the update processing program, the control unit enters into a normal processing mode (relay processing mode). The switch program (self-reprogram program) is executed, for example, by the control unit according to campaign information transmitted by an external server such as an OTA server or a program providing device (diagnostic device) used by authorized dealers and the like. The external server (OTA server) and the program providing device (diagnostic device) corresponds to the vehicle-outside device. By executing the switch program, the control unit transitions to a switch mode (self-reprogram mode) from the normal processing mode. The control unit, having transitioned to the switch mode (the control unit now executing the switch program) by executing the switch program (self-reprogram program), obtains, from the vehicle-outside device, the update processing program for performing update processing for the in-vehicle ECU. While executing the switch program, the control unit transitions to an update processing mode by executing the obtained update processing program. While executing the switch program, the control unit stores the update processing program obtained from the vehicle-outside device in the storage unit by using the storage area where the relay processing program is stored. That is, while executing the switch program, the control unit rewrites the relay processing program stored in the storage unit with the update processing program. As a result, it is possible to make use of the storage area that stores the relay processing program, which does not need to be executed during update processing, to secure the freed-up storage area (free space) as a buffer where the update program obtained from the vehicle-outside device can be efficiently stored (buffered). In this way, even if the volume of the update program obtained from the vehicle-outside device has increased, it is possible to cope with the increased volume by using, as a buffer area, the storage area that stores the relay processing program, which does not need to be executed during update processing. As such, it is possible to suppress an increase in the storage capacity of the storage unit, or to reduce the processing time by eliminating the need to download the update program in a plurality of sessions for update processing. It should be noted that the control unit is capable of executing self-programming to rewrite its own program during program execution.

In the relay device according to one aspect of the present disclosure, while executing the update processing program, the control unit executes the switch program after the update program is output to the in-vehicle ECU to be updated; and while performing the switch program, the control unit recovers the relay processing program.

In such an aspect, after the update program is output to the in-vehicle ECU to be updated, the control unit, while executing the update processing program, transits to the switch mode (self-reprogram mode) by executing the switch program. While executing the switch program, the control unit can start relay processing with the in-vehicle ECU (transit to the normal processing mode) by restoring the relay processing program and executing the restored relay processing program.

In the relay device according to one aspect of the present disclosure, while executing the switch program, the control unit: stores the obtained update processing program in the storage unit by overwriting the storage area where the relay processing program is stored; and restores the relay processing program by obtaining the relay processing program that has been overwritten from the vehicle-outside device.

In such an aspect, when the control unit, while executing the switch program, stores the update processing program obtained from the vehicle-outside device in the storage unit by using the storage area that stores the relay processing program, it is possible to efficiently restore the relay processing program by obtaining the relay processing program from the vehicle-outside device even if the relay processing program is overwritten. This overwrite processing includes deleting the relay processing program from the storage area that stores the relay processing program to free up the area, and then storing (writing) the update processing program in the freed-up storage area.

In the relay device according to one aspect of the present disclosure, while executing the switch program, the control unit: frees up the storage area where the relay processing program is stored by compressing the relay processing program; stores the obtained update processing program in the storage unit by using the freed-up storage area; and restores the relay processing program by decompressing the compressed relay processing program.

In such an aspect, when the control unit, while executing the switch program, stores the update processing program obtained from the vehicle-outside device in the storage unit by using the storage area that stores the relay processing program, the storage area is freed up, for example, by compressing the relay processing program so as to store the update processing program in the free-up storage area. Even in this case, as the compressed relay processing program is stored in the storage unit, the relay processing program can be efficiently restored by decompressing the compressed relay processing program.

In the relay device according to one aspect of the present disclosure, the relay processing program includes a non-generic program portion dependent on the vehicle and a generic program portion not dependent on the vehicle; wherein while executing the switch program, the control unit: frees up the storage area where the non-generic program portion is stored by compressing the non-generic program portion; stores the update processing program in the storage unit by using the freed-up storage area and the storage area where the generic program portion is stored; and restores the relay processing program by decompressing the compressed non-generic program portion and obtaining the generic program portion from the vehicle-outside device.

In such an aspect, in the non-generic program portion dependent on the vehicle and the generic program portion not dependent on the vehicle, the non-generic program portion can be compressed into a smaller volume to free up the storage area where the non-generic program portion is stored. In addition, as the compressed non-generic program portion is stored in the storage unit of the relay device, the non-generic program portion can be restored by decompressing the compressed non generic program portion, making it unnecessary to obtain the non-generic program portion from the vehicle-outside device. As the vehicle-outside device does not need to individually save and manage vehicle-dependent non-generic programs, it is possible to mitigate the complexity or complication of the saving and maintenance of the relay processing programs for relay devices in the vehicle-outside device. Furthermore, vehicle-nondependent generic programs are commonalized or standardized by the same vehicle types or car manufacturers, for example, and saved, in the vehicle-outside device. Therefore, the relay device (the control unit, while executing the switch program) can efficiently restore the generic program portion by obtaining the generic program portion from the vehicle-outside device.

In the relay device according to one aspect of the present disclosure, wherein the processing unit includes: a first storage section where a currently applied relay processing program is stored; and a second storage section where a previously applied relay processing program is stored; and wherein while executing the switch program, the control unit stores the obtained update processing program in the second storage section.

In such an aspect, the storage unit is configured as a dual-bank storage unit including a first storage section and a second storage section. The first storage section where the currently applied relay processing program and the relay processing program are stored functions as the work bank. The second storage section where the previously applied switch program and relay processing program are stored functions as the non-work bank. As the control unit, while executing the switch program, stores the update processing program obtained from the vehicle-outside device in the second storage section, which is the non-work bank, it is possible to maintain the currently applied update processing program and the relay processing program stored in the first storage section, which is the work bank. As a result, when transitioning to the normal processing mode from the update processing program, the control unit does not need to perform processing for restoring the relay processing program such as obtaining the relay processing program from the external server.

In the relay device according to one aspect of the present disclosure, while executing the switch program, the control unit: stores a part of the update processing program in a free storage area of the first storage section; and stores a remaining portion of the update processing program in the second storage section by using the storage area where the previously applied relay processing program is stored.

In such an aspect, the storage unit includes an area used as a work bank and an area used as a non-work bank, and the work bank and the non-work bank are configured to be switchable. That is, when the work bank is the first storage section, the non-work bank is the second storage section, and when the work bank is the second storage section, the non-work bank is the first storage section. The control unit, while executing the switch program, can secure a sufficient buffer area, as the free storage area of the work bank and the storage area of the non-work bank that stores the relay processing program are used to store the update processing program. To configure the work bank and the non-work bank to be switchable, the first storage section and the second storage section may be segmented. Conversely, when storing the update processing program, the control unit of the relay device may cancel or invalidate this segmentation and set the first storage section and the second storage section as a logically continuous storage area. As a result of the above, the update processing program can be stored by using the free storage area of the first storage section and the storage area where the previous relay processing program is stored (second storage section) so that a sufficient buffer area to store the update program to be applied to the in-vehicle ECU can be secured.

In the relay device according to one aspect of the present disclosure, the switch program has a smaller program size than the relay processing program.

In such an aspect, as the switch program has a smaller program size (the data volume of the executable file) than the relay processing program, it is possible to mitigate shortage of the free storage area of the storage unit. Moreover, the switch program may be formed in a smaller program size than the update processing program. In this way, the switch program may be formed in a smaller program size than the relay processing program and the update processing program by configuring the switch program as a module with a minimum configuration specialized for switching between the relay processing and the update processing. As a result of the above, whether the control unit is executing the relay processing (in the normal mode) or the update processing (in the reprogram mode), the program size of the switch program stored in the storage unit can be reduced to efficiently secure a freed-up storage area in the storage unit.

A program according to one aspect of the present disclosure causes a computer that obtains an update program transmitted from a vehicle-outside device and performs processing for updating a program of an in-vehicle ECU mounted in a vehicle and includes a storage unit having stored thereon a relay processing program used during relay processing and a switch program for switching between relay processing and update processing, to execute the switch program to thereby perform processing for: obtaining an update processing program for performing update processing from the vehicle-outside device; storing the obtained update processing program in the storage unit by using a storage area where the relay processing program is stored; and executing the update processing program stored in the storage unit to thereby cause a control unit, while executing the update processing program, to output the update program obtained from the vehicle-outside device to the in-vehicle ECU to be updated . . .

In such an aspect, it is possible to provide a program that causes a computer to function as a relay device capable of efficiently updating a program for an in-vehicle ECU when updating the program. The program corresponds to a control program stored in the storage unit of the computer, and the control program includes the switch program, the relay processing program, and the update processing program. By being sequentially executed by the computer, the switch program, the relay processing program, and the update processing program may operate as the program (control program) to perform a series of processes of the present aspect. Alternatively, the control program may include, in addition to the switch program, the relay processing program, and the update processing program, a program startup module to control the start and stop of each of these programs so that the program startup module may control the series of processes in the present aspect.

A method for updating a program causes a computer that obtains an update program transmitted from a vehicle-outside device and performs processing for updating a program of an in-vehicle ECU mounted in a vehicle and includes a storage unit having stored thereon a relay processing program used during relay processing and a switch program for switching between relay processing and update processing, to execute the switch program to thereby perform processing for: obtaining an update processing program for performing update processing from the vehicle-outside device; storing the obtained update processing program in the storage unit by using a storage area where the relay processing program is stored; and executing the update processing program stored in the storage unit to thereby cause a control unit, while executing the update processing program, to output the update program obtained from the vehicle-outside device to the in-vehicle ECU to be updated.

In such an aspect, it is possible to provide a method of updating that causes a computer to function as a relay device capable of efficiently updating a program for an in-vehicle ECU when updating the program.

The present disclosure will be described in detail with reference to the drawings illustrating embodiments thereof. A relay device 2 according to the embodiments of the present disclosure will be described below with reference to the drawings. It should be noted that the present disclosure is not limited to these examples, but rather is indicated by the claims, and all changes that come within the meaning and range of equivalency of the claims are intended to be embraced therein.

### First Embodiment

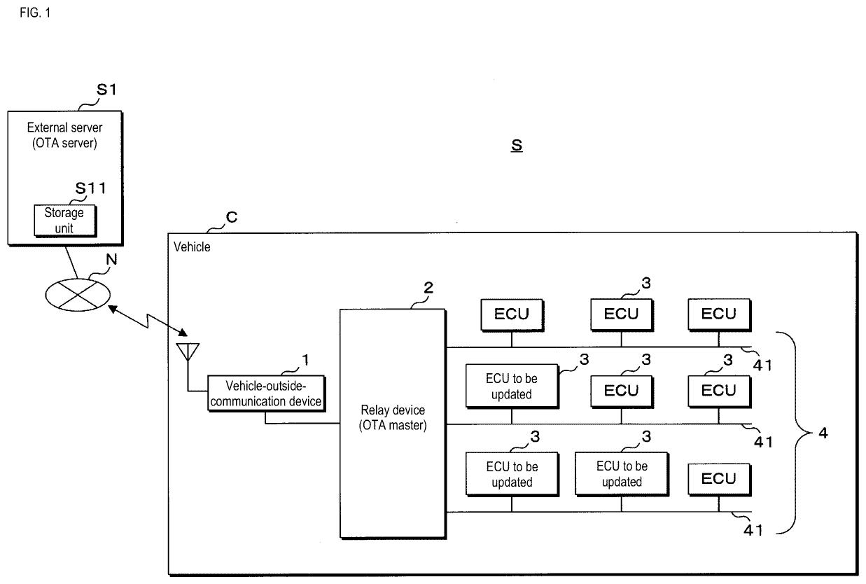

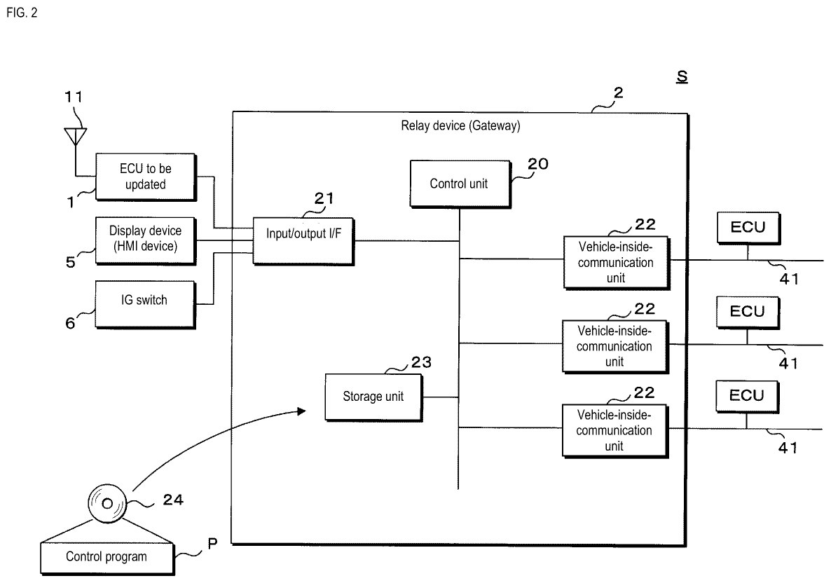

The following describes the embodiments based on the drawings. FIG. 1 is a schematic view illustrating a configuration of an in-vehicle update system that includes the relay device 2 according to a first embodiment. FIG. 2 is a block diagram illustrating a physical configuration of the relay device 2. The in-vehicle update system S includes a vehicle-outside-communication device 1 and the relay device 2, which are mounted in a vehicle C, and transmits an update program obtained from an external server (a program providing device or OTA server) S1 connected to the in-vehicle update system S via an external network N, to in-vehicle ECUs 3 (Electronic Control Units) mounted in the vehicle C.

The external server S1 is a computer such as a server connected to the external network N such as the Internet, or a public network, includes a storage unit S11 constituted by a RAM (Random Access Memory), a ROM (Read Only Memory), a hard disk, or the like, and corresponds to a program providing device outside the vehicle. A program or data created by the manufacturer or the like of the in-vehicle ECUs 3 for controlling the in-vehicle ECUs 3 is stored in the storage unit S11 of the external server S1. The program or data is transmitted to the vehicle C as an update program, as described later, and used to update the program or data of the in-vehicle ECUs 3 mounted in the vehicle C. The external server S1 (program providing device) configured as described above is also referred to as an OTA (Over The Air) server. The external server S1 corresponds to a vehicle-outside device that provides update programs and the like. The vehicle-outside device may be a program providing device (diagnostic device) used by authorized dealers and the like. In other words, the vehicle-outside device, which provides update programs and the like to the relay device 2, may include the external server S1 such as an OTA server and a program providing device such as a diagnostic device.

The relay device 2 functions an OTA master that transmits an update program obtained from the external server S1 to the in-vehicle ECUs 3 to be updated, and transmits an activation instruction for applying the transmitted update program to the in-vehicle ECUs 3. The in-vehicle ECUs 3 mounted in the vehicle C obtain the update program transmitted from the external server S1 via the relay device 2 through wireless communication, and apply the update program according to the activation instruction (activation processing), and thus the ECUs update (reprogram) the program to be executed by the in-vehicle ECUs 3 themselves.

In the following description, the program is assumed to include an external file in which a program code including control syntaxes and the like for performing processing by the in-vehicle ECUs 3 and data that is referred to when executing the program code are described. When transmitting the update program, the external file in which the program code and the data are described is transmitted from the external server S1 as an encrypted archive file, for example. When transmitting the update program, the external server S1 creates a package including the update program, and transmits the created package to the vehicle C. If a plurality of in-vehicle ECUs 3 is to be updated, the external server S1 may create update programs to be applied to the plurality of the respective in-vehicle ECUs 3 as a single package.

When transmitting the update program, the external server S1 may transmit campaign information, which is information related to program update, to the relay device 2. The relay device 2 can check the presence or absence of campaign information by communicating with the external server S1 and, according to the results of this check, determine whether or not update processing is required for the vehicle in which the relay device 2 (its own device) is mounted. The campaign information includes information (target information) related to one or more in-vehicle ECUs to be updated.

The vehicle-outside-communication device 1, the relay device 2, a display device 5, and the plurality of in-vehicle ECUs 3 for controlling various in-vehicle apparatuses are mounted in the vehicle C. The vehicle-outside-communication device 1 and the relay device 2 are communicably connected to each other by a harness such as a serial cable. The relay device 2 and the in-vehicle ECUs 3 are communicably connected to each other via an in-vehicle network 4 compatible with a communication protocol such as CAN (Control Area Network) or Ethernet (registered trademark).

The vehicle-outside-communication device 1 includes a vehicle-outside-communication unit (not shown) and an input/output I/F (interface) (not shown) for communicating with the relay device 2. The vehicle-outside-communication unit is a communication device for performing wireless communication using a mobile communication protocol such as 3G, LTE (registered trademark), 4G, 5G, or Wi-Fi (registered trademark), and transmits and receives data to and from the external server S1 via an antenna 11 connected to the vehicle-outside-communication unit. The communication between the vehicle-outside-communication device 1 and the external server S1 is performed through an external network N such as a public network or the Internet.

The input/output I/F of the vehicle-outside-communication device 1 is a communication interface for performing serial communication with the relay device 2, for example. The vehicle-outside-communication device 1 and the relay device 2 communicate with each other through a harness such as a serial cable connected to the input/output I/Fs. In the present embodiment, the vehicle-outside-communication device 1 is a device separate from the relay device 2, and these devices are communicably connected to each other through the input/output I/F and the like, but the present disclosure is not limited to this configuration. The vehicle-outside-communication device 1 may also be built into the relay device 2 as a constituent part of the relay device 2. Alternatively, the vehicle-outside-communication device 1 and the relay device 2 may be connected to each other by the in-vehicle network 4 of CAN or the like.

The relay device 2 includes a control unit 20, a storage unit 23, an input/output I/F 21, and vehicle-inside-communication units 22. The relay device 2 is configured to obtain, from the vehicle-outside-communication device 1, the update program (package) received by the vehicle-outside-communication device 1 from the external server S1 through wireless communication, and transmit the update program to a predetermined in-vehicle ECU 3 (in-vehicle ECU 3 to be updated) through the in-vehicle network 4. In other words, the relay device 2 functions as an OTA master (reprogram master) that controls the program update in the in-vehicle ECU 3 to be updated.

The relay device 2 is, for example, a gateway that controls buses (segments) of a plurality of systems such as in-vehicle ECUs 3 of a control system, in-vehicle ECUs 3 of a safety system, and in-vehicle ECUs 3 of a body system, and relays communication between the in-vehicle ECUs 3 through the buses (segments). In other words, communication lines 41 constituting the plurality of respective buses (segments) are connected to the relay device 2, and the in-vehicle network 4 is constituted by the communication lines 41 (segments) consolidated by the relay device 2. The relay device 2 functions as a CAN gateway in relay according to the CAN or CAN-FD protocol, and functions as a layer 2 switch or a layer 3 switch in relay according to the TCP/IP protocol. The relay device 2 may be a PLB (Power Lan Box) that also functions as a power distribution device that distributes and relays power output from a power supply device such as a secondary battery, and supplies power to in-vehicle devices such as actuators connected to the relay device 2, in addition to relaying related to communication. Alternatively, the relay device 2 may also be configured as a functional unit of a body ECU that performs overall control of the vehicle C. Furthermore, the relay device 2 may also be an integrated ECU that includes a central processing unit such as a vehicle computer, and that performs overall control of the vehicle C.

The control unit 20 is configured, for example, by a CPU (Central Processing Unit), an MPU (Micro Processing Unit), and performs various control processes, computational processes, and the like by loading and executing a control program P (program product) and data stored in advance in the storage unit 23. As described in detail below, the control program P includes a switch program P1 (self-reprogram program), a relay processing program P2 (control GW program), and an update processing program P3 (reprogram GW program). By executing the switch program P1, the control unit 20 transitions to a switch mode (self-reprogram mode). By executing the relay processing program P2, the control unit 20 transitions to a normal processing mode (relay processing mode). By executing the update processing program P3, the control unit 20 transitions to an update processing mode (reprogram mode).

The storage unit 23 is configured by a volatile memory device such as a RAM (Random Access Memory) or a nonvolatile memory device such as a ROM (Read Only Memory), an EEPROM (Electrically Erasable Programmable ROM), or a flash memory. A control program P (program product) stored in the storage unit 23 may be a control program P (program product) that has been read from a recording medium 24 that is readable by the relay device 2. Also, the control program P may be a control program that is downloaded from an external computer (not shown) connected to a communication network (not shown), and that is stored in the storage unit 23.

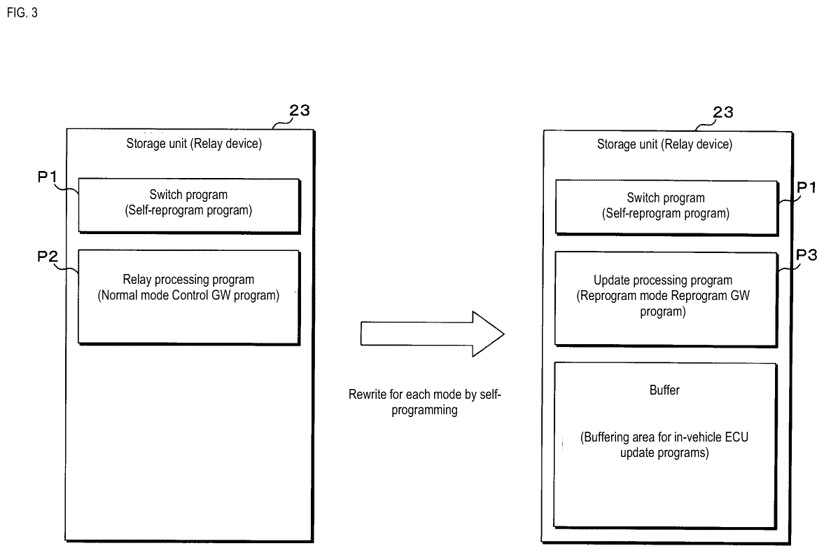

FIG. 3 is an explanatory view illustrating a state of the storage unit 23 of the relay device 2. When the control unit 20 is in the normal processing mode (relay processing mode), the switch program P1 and the relay processing program P2 are stored in the storage unit 23. When the control unit 20 is in the update processing mode (reprogram mode), the switch program P1 and the update processing program P3 are stored in the storage unit 23.

When the control unit 20 is in the switch mode (self-reprogram mode), the relay processing program P2 is switched (overwritten) with the update processing program P3 by the control unit 20, which is executing the switch program P1. In this way, the storage area that stores the relay processing program P2 is overwritten by the update processing program P3, thereby securing a sufficient free area in the storage unit 23.

Storing of the update processing program P3 in the storage unit 23 is not limited to overwriting the relay processing program P2; rather, a storage area freed up (free space) by compressing the relay processing program P2 may be used to store the update processing program P3. In this case, the freed-up storage area (free space) in the storage unit 23 becomes a buffer area and is used as the area for buffering update programs for the in-vehicle ECUs 3.

To output (transmit) the update programs obtained (received) from the external server to the in-vehicle ECUs 3, the relay device 2 needs to buffer the update programs due to the difference in bandwidth between input and output of the relay device 2 and the like. Also in this case, as described above, when the control unit 20 is in the update processing mode (reprogram mode), the relay processing program P2 is overwritten by the update processing program P3, thereby securing a sufficient free area for buffering. As such, even if the volume of the update programs obtained from the vehicle-outside device has increased, in order to cope with the increased volume, it is possible to suppress an increase in the storage volume of the storage unit 23, or to reduce the processing time by eliminating the need to download the update programs in a plurality of sessions for update processing.

Similar to the input/output of the vehicle-outside-communication device 1, the input/output I/F 21 is a communication interface for performing serial communication, for example. The relay device 2 is communicably connected, via the input/output I/F, to the vehicle-outside-communication device 1, the display device 5 such as an HMI (Human machine interface) device, and the IG switch 6. The control unit 20 may also be capable of displaying the current operation mode of the control unit 20 (the relay device 2) on the display device 5 by outputting information related to the current operation mode (the normal processing mode, switch mode, or update processing mode) to the display device 5.

The vehicle-inside-communication units 22 are each an input/output interface using a communication protocol of, for example, CAN, CAN-FD, or Ethernet (registered trademark), etc., and the control unit 20 communicates with the in-vehicle ECUs 3 connected to the in-vehicle network 4 via the vehicle-inside-communication units 22 or in-vehicle devices such as other relay devices 2. The relay device 2 is provided with a plurality of (three in this embodiment) vehicle-inside-communication units 22, and a plurality of communication lines 41 (segments) constituting the in-vehicle network 4 are connected to the plurality of vehicle-inside-communication units 22, respectively. By providing the vehicle-inside-communication units 22 in this manner, the in-vehicle network 4 may be divided into a plurality of segments, and the in-vehicle ECUs 3 are respectively connected to the segments, for example, according to the function (the control system function, the safety system function, or the body system function) of the in-vehicle ECUs 3.

Similarly to the relay device 2, the in-vehicle ECUs 3 each include a control unit 20, a storage unit, and a vehicle-inside-communication unit (not shown). The storage unit 23 is constituted by a volatile memory device such as a RAM (Random Access Memory) or a non-volatile memory device such as a ROM (Read Only Memory), an EEPROM (Electrically Erasable Programmable ROM), or a flash memory, and stores a program or data of the in-vehicle ECU 3. The program or data is to be updated by an update program transmitted from the program providing device and relayed by the relay device 2. Similarly to the relay device 2, the vehicle-inside-communication unit of each of the in-vehicle ECUs 3 is configured by, for example, a CAN transmitter/receiver or an Ethernet PHY unit, and communicates with the relay device 2 through the vehicle-inside-communication units.

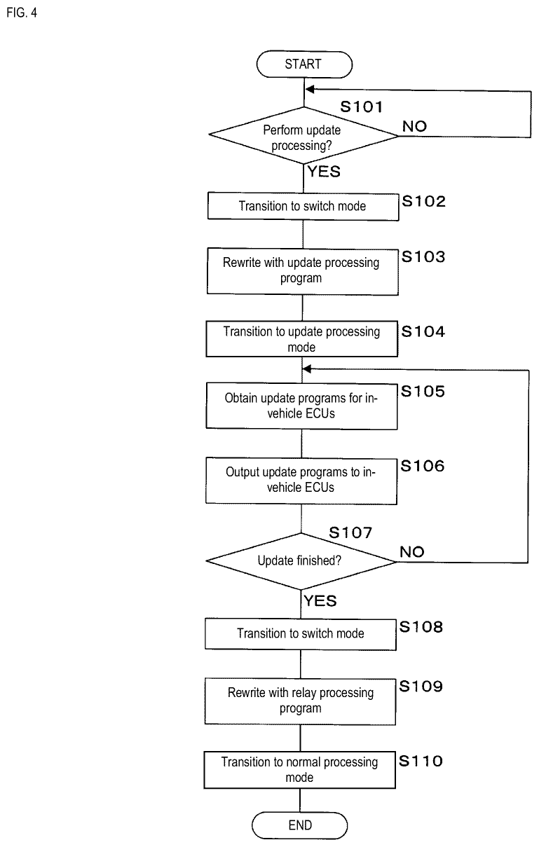

FIG. 4 is a flowchart illustrating processing performed by the control unit 20 of the in-vehicle device. The control unit 20 of the relay device 2 constantly performs the following processing, for example, when the vehicle C is in a stop state (a state in which the IG switch 6 is off).

The control unit 20 of the relay device 2 communicates with the external server S1 to determine whether or not any in-vehicle ECU 3 needs to be updated (step S101). When the control unit 20 of the relay device 2 is in the normal processing mode (relay processing mode), in which the relay processing program P2 is being executed, or has obtained an off signal indicating the IG switch 6 is turned off, the control unit 20 communicates with the external server S1 using the VIN (Vehicle Identification Number) or the like to check the presence or absence of campaign information related to update processing for any in-vehicle ECU 3. The campaign information includes, for example, information (target information) related to the in-vehicle ECUs 3 to be updated and the like. If the control unit 20 of the relay device 2 has received campaign information from the external server S1, it is determined that update processing is required for the in-vehicle ECUs 3, and if there is no campaign information in the external server S1 so that no campaign information has been received, it is determined that no update processing is required for the in-vehicle ECUs 3.

The control unit 20 of the relay device 2 regularly or periodically obtains, from all of the in-vehicle ECUs 3 mounted in the vehicle C, information regarding programs applied to the in-vehicle ECUs 3 and the type information, and stores the obtained and aggregated information in the storage unit 23 as the vehicle C configuration information. The control unit 20 of the relay device 2 can identify one or more in-vehicle ECUs 3 to be updated by referring to the obtained campaign information and the vehicle C configuration information. If it is determined that update processing is required for no in-vehicle ECUs 3 (NO in step S101), the control unit 20 of the relay device 2 performs loop processing to perform the processing in step S101 again.

If it is determined that update processing is required for any in-vehicle ECU 3 (YES in step S101), the control unit 20 of the relay device 2 transitions to the switch mode by performing the switch program P1 (step S102). When it is determined that update processing is required for any in-vehicle ECU 3 (campaign information present), the control unit 20 of the relay device 2 performs the switch program P1. As a result of the above, the control unit 20 of the relay device 2, now executing the switch program P1, transitions to the switch mode (self-reprogram mode). While executing the switch program P1 (switch mode), the control unit 20 may stop executing the relay processing program P2 (terminating the process).

The control unit 20 of the relay device 2 rewrites the relay processing program P2 with the update processing program P3 obtained from the external server S1 (step S103). While executing the switch program P1, the control unit 20 obtains the update processing program P3 from the external server S1 and stores the update processing program P3 in the storage unit 23 by using the storage area in which the relay processing program P2 is stored. As a result of the above, while executing the switch program P1, the control unit 20 rewrites the relay processing program P2 with the update processing program P3. In other words, the storage area of the relay processing program P2 is overwritten by the update processing program P3. This overwrite processing includes deleting the relay processing program P2 from the storage area that stores the relay processing program P2 to free up the area, and then storing (writing) the update processing program P3 in the freed-up storage area.

By executing the update processing program P3, the control unit 20 of the relay device 2 transitions to the update processing mode (step S104). While executing the switch program P1, the control unit 20 executes the update processing program P3. As a result of the above, the control unit 20 of the relay device 2, now executing the update processing program P3, transitions to the update processing mode (reprogram mode). To transition to the update processing mode, the control unit 20, while executing the update processing program P3, may either terminate the switch program P1 or cause the switch program P1 to be in a standby processing state by executing the process thereof in the background, for example.

The control unit 20 of the relay device 2 obtains update programs for the in-vehicle ECUs 3 from the external server S1 (step S105). While executing the update processing program P3, the control unit 20 obtains (receives) an update program for one or more in-vehicle ECUs 3 from the external server S1 according to the campaign information, stores (buffers) the obtained update program in the buffer area of the storage unit 23. If a plurality of in-vehicle ECUs 3 is to be updated this time, the control unit 20 of the relay device 2 may obtain the update programs for all the plurality of in-vehicle ECUs 3 as a single package. A free area has been secured in the storage unit 23 of the relay device 2 by overwriting the relay processing program P2, which is used in the normal processing mode, with the update processing program P3 in the storage unit 23. As the free area is used as a buffer, even if the total program size of the update programs for all the plurality of in-vehicle ECUs 3 amounts to a large volume, processing time can be reduced by eliminating the need for downloading the update programs in a plurality of sessions to perform update processing.

The control unit 20 of the relay device 2 outputs the obtained update programs to the in-vehicle ECUs 3 (step S106). While executing the update processing program P3, the control unit 20 identifies the one or more in-vehicle ECUs 3 to be updated by referring to the campaign information and the vehicle C configuration information, and transmits the new programs buffered in the storage unit 23 to the in-vehicle ECUs 3.

The control unit 20 of the relay device 2 determines whether or not the update processing for all the in-vehicle ECUs 3 has been completed (step S107). While executing the update processing program P3, the control unit 20 determines whether or not the update programs have been output to, and operation check has been completed for, all the in-vehicle ECUs 3 to be updated. While executing the update processing program P3, the control unit 20 may determine that the update processing for all the in-vehicle ECUs 3 has been completed upon receiving signals indicating that operation check has been normally completed (normal termination signals) from all the in-vehicle ECUs 3 to be updated. While executing the update processing program P3, the control unit 20 may determine that the update processing for all the in-vehicle ECUs 3 has not been completed if the control unit 20 has not received a normal termination signal from any of the in-vehicle ECUs 3.

If it is determined that update processing for all the in-vehicle ECUs 3 has not been completed (NO in step S107), the control unit 20 of the relay device 2 performs loop processing to perform the processing from step S105 again. When the update programs for all the in-vehicle ECUs 3 to be updated this time have been obtained from the external server S1, the control unit 20 of the relay device 2 may perform loop processing to perform the processing from step S106 or S107. It should be noted that the control unit 20, while executing the switch program P1, may perform rollback processing to restore the old version programs to all the in-vehicle ECUs 3 to be updated if the control unit 20 has received a signal indicating abnormal termination of operation check (abnormal termination signal) from any of all the in-vehicle ECUs 3 to be updated. In this case, while executing the switch program P1, the control unit 20 may perform the processing from step S209 after the rollback processing.

If it is determined that the update processing has been completed for all the in-vehicle ECUs 3 (YES in step S107), the control unit 20 of the relay device 2 transitions to the switch mode by performing the switch program P1 (step S108). The control unit 20, while executing the update processing program P3, executes the switch program P1. As a result of the above, the control unit 20 of the relay device 2, now executing the switch program P1, transitions to the switch mode (self-reprogram mode). The present disclosure is not limited to the case in which the control unit 20 of the relay device 2 executes the switch program P1 again to transition from the update processing mode to the switch mode, but the process of the switch program P1 set in a standby processing state by executing the process in the background or the like may be set in an activated state by executing the process in the foreground or the like to restart the processing of the switch program P1, for example.

The control unit 20 of the relay device 2 rewrites the update processing program P3 with the relay processing program P2 obtained from the external server S1 (step S109). While executing the switch program P1, the control unit 20 obtains the relay processing program P2 from the external server S1 and stores the relay processing program P2 in the storage unit 23 by using the storage area in which the update processing program P3 is stored, thereby recovering the relay processing program P2. As a result of the above, the control unit 20, while executing the switch program P1, rewrites the update processing program P3 with the relay processing program P2. In other words, the storage area of the update processing program P3 is overwritten by the relay processing program P2.

The present disclosure is not limited to the case in which, when obtaining the relay processing program P2 from the external server S1, the control unit 20 of the relay device 2 obtains the same (i.e., the same version of) relay processing program P2 as the overwritten relay processing program P2; rather, the control unit 20 may also obtain a new version of the relay processing program P2. In other words, in this update processing, if the relay device 2 is also to be updated in addition to the in-vehicle ECUs 3 to be updated, the control unit 20, while executing the switch program P1, can also perform update processing regarding the relay device 2, i.e., its own device, by obtaining a new version of the relay processing program P2.

By executing the relay processing program P2, the control unit 20 of the relay device 2 transitions to the normal processing mode (step S110). While executing the switch program P1, the control unit 20 executes the relay processing program P2. As a result of the above, the control unit 20 of the relay device 2, now executing the relay processing program P2, transitions to the normal processing mode (relay processing mode). While executing the relay processing program P2, the control unit 20 may also restart the relay processing or the like, which is the function performed during the normal control in the vehicle C.

### Second Embodiment

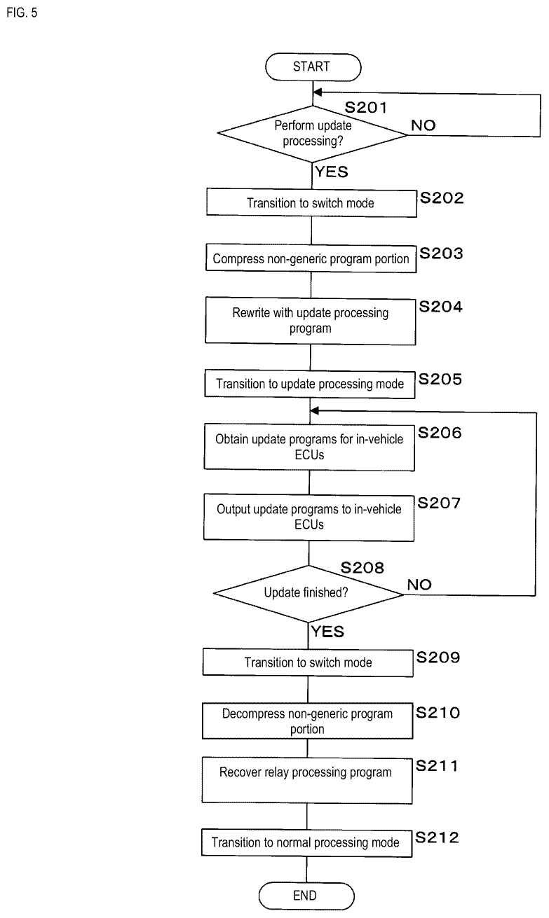

FIG. 5 is a flowchart about a second embodiment (for compressing a non-generic program portion). The control unit 20 of the relay device 2 communicates with the external server S1 to determine whether or not any in-vehicle ECU 3 needs to be updated (step S201). By executing the switch program P1, the control unit 20 of the relay device 2 transitions to the switch mode (step S202). Similar to the process from step S101 to step S102 of the first embodiment, the control unit 20 of the relay device 2 performs the process from step S201 to step S202.

The control unit 20 of the relay device 2 compresses a non-generic portion of the relay processing program P2 (step S203). The relay processing program P2 stored in the storage unit 23 includes a non-generic program portion dependent on the vehicle C (its own vehicle) on which the relay device 2 is to be mounted and a generic program portion not dependent on the vehicle C. The generic program portion is, for example, a program part including a group of modules commonalized or standardized by the same vehicle type or car manufacturer. The non-generic program portion is, for example, a group of modules varying from vehicle C to vehicle C on which the relay device 2 is mounted or includes configuration data and the like including setting information such as parameters and the like that is dependent on the vehicle C. The generic program portion and the non-generic program portion, in combination, constitute the relay processing program P2.

While executing the switch program P1, the control unit 20 reduces the program size of the non-generic program portion by compressing the non-generic program portion, which constitutes a part of the relay processing program P2. If the compressed non-generic program portion is generated separately from the original non generic program portion, the control unit 20 of the relay device 2 may delete the original non-generic program portion. A free area is created in the storage area in which the non-generic program portion was stored according to the compression ratio to compress the non-generic program portion.

The control unit 20 of the relay device 2 rewrites the relay processing program P2 with the update processing program P3 obtained from the external server S1 (step S204). Similar to the first embodiment, the control unit 20, while executing the switch program P1, obtains the update processing program P3 from the external server S1. While executing the switch program P1, the control unit 20 stores a part of the update processing program P3 in the storage area freed up by compressing the non-generic program portion, and stores the remaining portion of the update processing program P3 in the storage unit 23 by using the storage area where the generic program portion is stored. With this configuration, the control unit 20, while executing the switch program P1, rewrites the generic program portion, which constitutes a part of the relay processing program P2, with the update processing program P3, and the control unit 20 meanwhile retains the non-generic program portion by compressing that portion (storing the compressed non-generic program portion).

By executing the update processing program P3, the control unit 20 of the relay device 2 transitions to the update processing mode (step S205). The control unit 20 of the relay device 2 obtains update programs for the in-vehicle ECUs 3 from the external server S1 (step S206). The control unit 20 of the relay device 2 outputs the obtained update programs to the in-vehicle ECUs 3 (step S207). The control unit 20 of the relay device 2 determines whether or not the update processing for all the in-vehicle ECUs 3 has been completed (step S208). By executing the switch program P1, the control unit 20 of the relay device 2 transitions to the switch mode (step S209). Similar to the process from step S104 to step S108 of the first embodiment, the control unit 20 of the relay device 2 performs the process from step S205 to step S209.

The control unit 20 of the relay device 2 decompresses the non-generic portion (step S210). While executing the switch program P1, the control unit 20 decompresses the compressed non-generic program portion that is stored in the storage. As a result, the non-generic program portion is recovered. To decompress the compressed non generic program portion, the control unit 20, while executing the switch program P1, may delete the update processing program P3 stored in the storage unit 23.

The control unit 20 of the relay device 2 recovers the relay processing program P2 (step S211). While executing the switch program P1, the control unit 20 obtains the generic program portion, which constitutes a part of the relay processing program P2, from the external server S1, and stores the generic program portion in the storage unit 23 by using the storage area in which the update processing program P3 was stored. While executing the switch program P1, the control unit 20 recovers the relay processing program P2 from the decompressed non generic program portion and the generic program portion obtained from the external server S1.

By executing the relay processing program P2, the control unit 20 of the relay device 2 transitions to the normal processing mode (step S212). Similar to the process from step S110 of the first embodiment, the control unit 20 of the relay device 2 performs the process of step S212.

### Third Embodiment

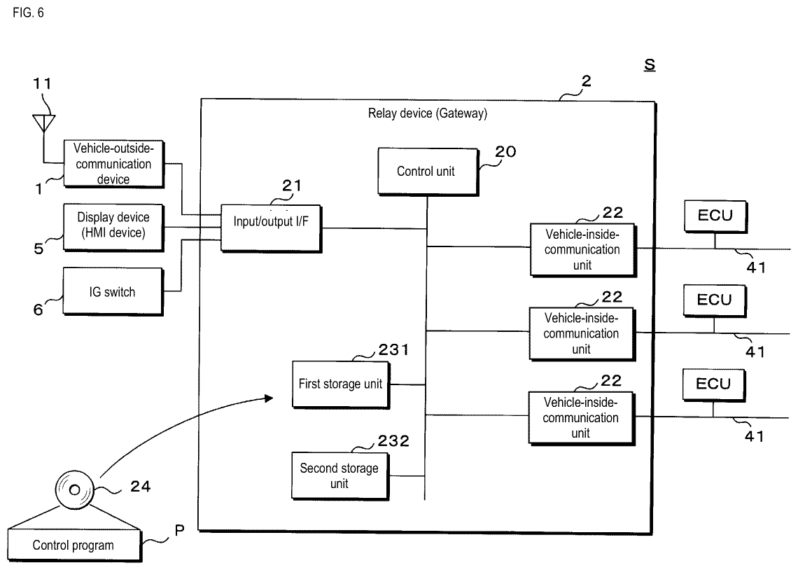

FIG. 6 is a block diagram illustrating a physical configuration of a relay device 2 related to a third embodiment (a dual bank). The storage unit 23 of the relay device 2 according to the third embodiment includes two storage areas, namely a first storage section 231 and a second storage section 232. The first storage section 231 and the second storage section 232 are each configured by a volatile memory device such as a RAM (Random Access Memory) or a nonvolatile memory device such as a ROM (Read Only Memory), an EEPROM (Electrically Erasable Programmable ROM), or a flash memory. The switch program P1 and the relay processing program P2 are stored in advance in each of the first storage section 231 and the second storage section 232. The first storage section 231 and the second storage section 232 may be configured, for example, by separate storage devices, or they may be segmented by physical address ranges in the same storage device.

The storage unit 23 (the first storage section 231 and the second storage section 232) has stored thereon version information related to two versions, namely, a current version and an old version of each of two control programs P (the switch program P1 and the relay processing program P2) and information related to the area in which the currently executing (applied) control programs P are stored (the work bank). That is, if the control programs P stored in the first storage section 231 (the first bank) are currently being executed, the first storage unit 231 stores an indication that the work bank is the first storage section 231 (the first bank). In this case, an indication is stored that the non-work bank is the second storage section 232 (the second bank).

The first storage section 231, which is the work bank, stores the current version of the control programs P (the switch program P1 and the relay processing program P2). The second storage section 232, which is the non-work bank, stores the old version of the control programs P (the switch program P1 and the relay processing program P2). Alternatively, the second storage section 232, which is the non-work bank, may not store the old version of the control programs P or the like so as to provide a free storage area. In this way, as the non-work bank is a free storage area or stores the old version of the control programs P or the like, a rollback to the old version is guaranteed by writing a new version of the control programs P to the non-operating bank during update.

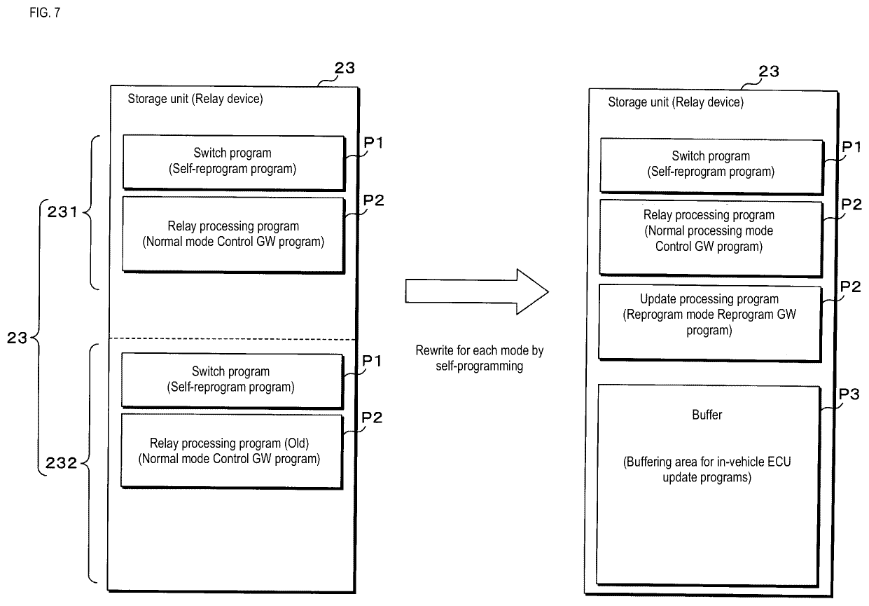

FIG. 7 is an explanatory view illustrating a state of the storage unit 23 of the relay device 2. When the control unit 20 is in the normal processing mode (relay processing mode), the first storage section 231 (first bank), which is the work bank, stores the current versions of the switch program P1 and the relay processing program P2, and the second storage section 232 (second bank), which is the non-work bank, stores the old versions of the switch program P1 and the relay processing program P2.

When the control unit 20 is in the update processing mode (reprogram mode), the first storage section 231 (first bank), which is the work bank, stores the current versions of the switch program P1 and the relay processing program P2, and the second storage section 232 (second bank), which is the non-work bank, stores the update processing program P3. That is, the old versions of the switch program P1 and the relay processing program P2, which were stored in the second storage section 232 (second bank), which is the non-work bank, are to be overwritten by the update processing program P3. As a result of the above, it is possible to retain the switch program P1 and the relay processing program P2 stored in the first storage section 231, which is the work bank.

To store the update processing program P3 in the storage unit 23, the present disclosure is not limited to the case in which the update processing program P3 is stored only in the second storage section 232. Rather, the free area of the first storage section 231, which is the work bank, may be used to store a part of the update processing program P3, and the remaining part of the update processing program P3 may be stored in the second storage section 232, which is the non-work bank, i.e., overwrite the old versions of the switch program P1 and the relay processing program P2. When storing the update processing program P3 across the first storage section 231 and the second storage section 232, the control unit 20 may cancel or invalidate the segmentation between the first storage section 231 and the second storage section 232. The segmentation may be cancelled by configuring the first storage section 231 and the second storage section 232 as a logically continuous storage area, namely, configuring logical addresses so that the first storage section 231 and the second storage section 232 form a logically continuous storage area.

A sufficient free area can be secured in the second storage section 232 (the storage unit 23) by overwriting the old version of the relay processing program P2 and the like stored in the second storage section 232. In this case, the freed-up storage area (free space) in the second storage section 232 (the storage unit 23) becomes a buffer area that is used as the area for buffering an update programs for the in-vehicle ECUs 3. As such, even if the volume of the update programs has increased due to an increased number of in-vehicle ECUs 3 to be updated, it is possible to cope with the increased volume of the update programs.

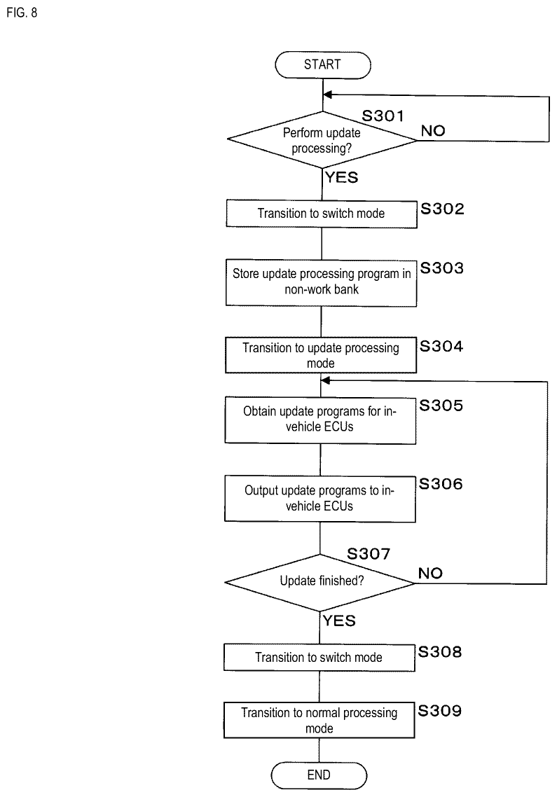

FIG. 8 is a flowchart illustrating processing performed by the control unit 20 of the in-vehicle device. The control unit 20 of the relay device 2 communicates with the external server S1 to determine whether or not any in-vehicle ECU 3 needs to be updated (step S301). By executing the switch program P1, the control unit 20 of the relay device 2 transitions to the switch mode (step S302). Similar to the process from step S101 to step S102 of the first embodiment, the control unit 20 of the relay device 2 performs the process from step S301 to step S302.

The control unit 20 of the relay device 2 stores the update processing program P3 in the non-work bank (step S303). While executing the switch program P1, the control unit 20 obtains the update processing program P3 from the external server S1, and stores the update processing program P3 in the storage unit 23 (the second storage section 232) by using the storage area in the non-work bank (the second storage section 232) that stores the relay processing program P2 or the like. As a result of the above, the control unit 20, while executing the switch program P1, rewrites the relay processing program P2 stored in the non-work bank (the second storage section 232) with the update processing program P3. In other words, the storage area of the relay processing program P2 and the like in the non-work bank (the second storage section 232) is overwritten by the update processing program P3.

By executing the update processing program P3, the control unit 20 of the relay device 2 transitions to the update processing mode (step S304). The control unit 20 of the relay device 2 obtains update programs for the in-vehicle ECUs 3 from the external server S1 (step S305). The control unit 20 of the relay device 2 outputs the obtained update programs to the in-vehicle ECUs 3 (step S306). The control unit 20 of the relay device 2 determines whether or not the update processing for all the in-vehicle ECUs 3 has been completed (step S307). By executing the switch program P1, the control unit 20 of the relay device 2 transitions to the switch mode (step S308). Similar to the process from step S104 to step S108 of the first embodiment, the control unit 20 of the relay device 2 performs the process from step S304 to step S308.

By executing the relay processing program P2, the control unit 20 of the relay device 2 transitions to the normal processing mode (step S309). While executing the switch program P1, the control unit 20 executes the relay processing program P2 stored in the work bank (the first storage section 231). As a result of the above, the control unit 20 of the relay device 2, now executing the relay processing program P2, transitions to the normal processing mode (relay processing mode). As described above, the need for processing such as obtaining the relay processing program P2 from the external server S1 can be eliminated by storing the update processing program P3 in the non-work bank (the second storage section 232) without overwriting the relay processing program P2 stored in the work bank (the first storage section 231).

The embodiments disclosed herein are exemplary in all respects, and should be construed as being not limitative. The scope of the present disclosure is indicated by the claims rather than by the foregoing description, and all changes which come within the meaning and range of equivalency of the claims are intended to be embraced therein.

1. A relay device for obtaining an update program transmitted from a vehicle-outside device and performing processing for updating a program of an in-vehicle ECU mounted in a vehicle, the relay device comprising:
a control unit for performing relay processing with the in-vehicle ECU; and
a storage unit having stored thereon a relay processing program used during relay processing and a switch program for switching between relay processing and update processing;
wherein while executing the switch program, the control unit:
obtains an update processing program for performing update processing from the vehicle-outside device;
stores the obtained update processing program in the storage unit by using a storage area where the relay processing program is stored; and
executes the update processing program stored in the storage unit; and
wherein while executing the update processing program, the control unit outputs the update program obtained from the vehicle-outside device to the in-vehicle ECU to be updated.

2. The relay device according to claim 1, wherein while executing the update processing program, the control unit executes the switch program after the update program is output to the in-vehicle ECU to be updated; and
wherein while executing the switch program, the control unit recovers the relay processing program.

3. The relay device according to claim 2, wherein while executing the switch program, the control unit:
stores the obtained update processing program in the storage unit by overwriting the storage area where the relay processing program is stored; and
restores the relay processing program by obtaining the relay processing program that has been overwritten from the vehicle-outside device.

4. The relay device according to claim 2, wherein while executing the switch program, the control unit:
frees up the storage area where the relay processing program is stored by compressing the relay processing program;
stores the obtained update processing program in the storage unit by using the freed-up storage area; and
restores the relay processing program by decompressing the compressed relay processing program.

5. The relay device according to claim 2, wherein the relay processing program includes a non-generic program portion dependent on the vehicle and a generic program portion not dependent on the vehicle;
wherein while executing the switch program, the control unit:
frees up the storage area where the non-generic program portion is stored by compressing the non-generic program portion;
stores the update processing program in the storage unit by using the freed-up storage area and the storage area where the generic program portion is stored; and
restores the relay processing program by decompressing the compressed non-generic program portion and obtaining the generic program portion from the vehicle-outside device.

6. The relay device according to claim 1, wherein the storage unit includes:
a first storage section where a currently applied relay processing program is stored; and
a second storage section where a previously applied relay processing program is stored; and
wherein while executing the switch program, the control unit stores the obtained update processing program in the second storage section.

7. The relay device according to claim 6, wherein while executing the switch program, the control unit:
stores a part of the update processing program in a free storage area of the first storage section; and
stores a remaining portion of the update processing program in the second storage section by using the storage area where the previously applied relay processing program is stored.

8. The relay device according to claim 1, wherein the switch program has a smaller program size than the relay processing program.

9. A program for causing a computer that obtains an update program transmitted from a vehicle-outside device and performs processing for updating a program of an in-vehicle ECU mounted in a vehicle and includes a storage unit having stored thereon a relay processing program used during relay processing and a switch program for switching between relay processing and update processing, to execute the switch program to thereby perform processing for:
obtaining an update processing program for performing update processing from the vehicle-outside device;
storing the obtained update processing program in the storage unit by using a storage area where the relay processing program is stored; and
executing the update processing program stored in the storage unit to thereby cause
a control unit, while executing the update processing program, to output the update program obtained from the vehicle-outside device to the in-vehicle ECU to be updated.

10. A method for updating a program for causing a computer that obtains an update program transmitted from a vehicle-outside device and performs processing for updating a program of an in-vehicle ECU mounted in a vehicle and includes a storage unit having stored thereon a relay processing program used during relay processing and a switch program for switching between relay processing and update processing, to execute the switch program to thereby perform processing for:
obtaining an update processing program for performing update processing from the vehicle-outside device;
storing the obtained update processing program in the storage unit by using a storage area where the relay processing program is stored; and
executing the update processing program stored in the storage unit to thereby cause
a control unit, while executing the update processing program, to output the update program obtained from the vehicle-outside device to the in-vehicle ECU to be updated.

11. The relay device according to claim 2, wherein the switch program has a smaller program size than the relay processing program.

12. The relay device according to claim 3, wherein the switch program has a smaller program size than the relay processing program.

13. The relay device according to claim 4, wherein the switch program has a smaller program size than the relay processing program.

14. The relay device according to claim 5, wherein the switch program has a smaller program size than the relay processing program.

15. The relay device according to claim 6, wherein the switch program has a smaller program size than the relay processing program.

16. The relay device according to claim 7, wherein the switch program has a smaller program size than the relay processing program.
